(19) United States
(12) Patent Application Publication
(10) Pub. No.: US 2003/0118293 A1
(43) Pub. Date: Jun. 26, 2003

(54) Snap together optoelectronic module

(75) Inventors: Dominic F. Canace, Edison, NJ (US); Ronald Nevo, Fair-Lawn, NJ (US)

Correspondence Address: Philip W.Woo, c/o Sidley Austin Brown & Wood LLP, 555 Califorinia Street, Suite 5000, San Francisco, CA, 94104-1715, US

(73) Assignee: Tyco Electronics Corporation

(21) Appl. No.: 10/036,970

(22) Filed: Dec. 21, 2001

(51) Int. Cl. G02B 6/42

(52) U.S. Cl. 385/92

(57) ABSTRACT

An optoelectronic transceiver module that is simple and inexpensive to manufacture and assemble and that provides easy access to the optical and electronic components therein during and after manufacture. The module also provides for movement of the optical subassemblies allowing adjustability in alignment with an optical fiber.

### FIELD OF THE INVENTION

The invention pertains to optoelectronic transmitter, receiver and transceiver modules. More particularly, the invention relates to optoelectronic modules that are inexpensive to manufacture, and easy to assemble and disassemble.

### BACKGROUND OF THE INVENTION

Optoelectronic transmitter, receiver and transceiver modules (herienafter modules) provide for the conversion of data between electrical signals and optical signals and the transfer of that data between an optical fiber and electronic circuitry. The term receiver is applied to a device that receives optical data and converts it to electrical data for transmission to further electronic circuitry. The term transmitter refers to a device that receives electrical data and converts it to optical data for transmission over an optical fiber. A transceiver generally refers to a device that contains both a receiver and a transmitter within a single housing and thus provides bidirectional communication. An optoelectronic module typically will be mounted onto a host circuit card that forms part of a host computer, input/output system, peripheral device or switch and also will be coupled, at the opposite end of the communication path through the module, to an optical fiber. Electrical signals are transferred between the host circuit card and the module. Optical signals are transferred between the optical fiber and the module.

An optoelectronic module typically comprises at least an optical subassembly (OSA), including an optical connector to couple the optical signals to and/or from an optical fiber electronic circuitry, electronic circuitry, including electrical connectors to couple the electrical signals to and/or from external electrical circuitry, such as a host circuit card, and a housing to enclose and protect the aforementioned optical and electronic components. Commonly, the electronic circuitry takes the form of a printed circuit board (PCB) containing various circuit components. The electrical connectors may comprise pins that protrude from the bottom of the PCB through the bottom of the housing for solder connection to the circuit card. Flexible ribbon cable and other connectors are also known. Each OSA includes a ferrule receiving bore for accepting the ferrule of the plug on the end of an optical fiber and precisely aligning the optical fiber contained in the ferrule with the optical axis of the OSA. The OSA further typically includes a lens system and an LED (in the case of a transmit OSA) or a photodiode (in the case of a receive OSA).

The module also includes a front end or nose designed to physically mate to a plug on the end of an optical fiber in accordance with one of the many well defined International standards. Some of the more common standards are SC, FC, and ST. These standards specify physical form factors and tolerances for the plugs and connectors that are to be matable in accordance with the standard. The nose is designed in accordance with the applicable form factor so that the plug body can be inserted into the nose and allow the ferrule of the plug to fit within the ferrule receiving bore of the OSA so that the optical fiber aligns properly with the optical path in the OSA.

In one common scheme, the housing for an optoelectronic module is comprised of an encapsulant that is injection molded around the optoelectronic components and cured. The optical connector or nose is a separate piece that mounts onto the front of the housing. In many prior art designs, the bottom of the PCB forms the bottom of the housing. In others, the PCB is set into a tray and then the assembly is encapsulated.

This encapsulation method has several draw backs. For instance, once the module is encapsulated, if any component of the device fails, either during testing during subsequent manufacturing stages or in the field, the module must be discarded since the individual components are inaccessible without destroying the module.

Further, as previously noted, when the optical subassembly is coupled to a mating plug on the end of an optical fiber, the optical path of the OSA and the fiber must align extremely precisely in order to minimize signal power loss. However, since the OSA is immovable within the encapsulant, there is no ability for the OSA to move relative to the nose. This could be a problem in terms of insertion of the ferrule into the ferrule receiving bore of the OSA and the alignment of the optical axis of the OSA with the optical fiber. Particularly, the coupling of the plug of the optical fiber to the module involves mating components of the nose of the module with the plug body as well as mating the ferrule of the plug with the ferrule receiving bore of the OSA. Any misalignment between the OSA within the module and the module nose could adversely affect alignment of the optical fiber to the optical axis of the OSA.

Accordingly, it is an object of the present invention to provide an improved optoelectronic module.

### SUMMARY OF THE INVENTION

The invention is an optoelectronic module, such as a transmitter, receiver or transceiver, comprising electronic circuitry and one or more optical subassemblies enclosed within a two-piece housing that can be opened at any time to expose the internal components for testing or replacement.

According to one embodiment of the invention, the two parts of the housing attach together by means of one or more latches that engage with mating shoulders on the other half.

According to another aspect of the invention, the optical subassembly(ies) are coupled to the printed circuit board via flex circuits. This enables the optical subassemblies to move when a plug is connected to them in order to facilitate better alignment of the optical subassembly with the optical fiber and/or nose of the module, if necessary.

According to another aspect of the invention, a conductive gasket may be provided circumscribing the nose of the module with fingers extending radially therefrom and adapted to contact the face plate of a chassis when the module is mounted to protrude through a face plate. The gasket provides electromagnetic interference shielding.

In accordance with an even further aspect of the present invention, the housing may be provided with flow-through slots to facilitate bathing of the module in aqueous solution, which is a common fabrication step. The flow-through slots allow the solution superior infiltration within the housing and superior flushing of the optoelectronic components within the housing.

### BRIEF DESCRIPTION OF THE DRAWINGS

FIG. 1 is a perspective view of a fully assembled optoelectronic transceiver module in accordance with the present invention.

FIG. 2 is an exploded view of an optoelectronic transceiver module in accordance with the present invention.

FIG. 3 is a perspective view of the top housing portion of an optoelectronic transceiver module in accordance with the present invention.

FIG. 4 is a perspective view of the bottom of the bottom housing portion of an optoelectronic transceiver module in accordance with the present invention.

FIG. 5 is a perspective view of the inside of the bottom housing portion of an optoelectronic transceiver module in accordance with the present invention.

FIG. 6 is a left side view of the printed circuit board and receive optical subassembly of an optoelectronic transceiver module in accordance with the present invention.

FIG. 7 is a right side view of the printed circuit board and transmit optical subassembly of an optoelectronic transceiver module in accordance with the present invention.

FIG. 8 is a bottom perspective view of an electromagnetic interference gasket that may be mounted on the nose of the optoelectronic transceiver module in accordance with the present invention.

FIG. 9 is a front elevation view of a fully assembled optoelectronic transceiver module in accordance with the present invention.

FIG. 10 is a plan view of the module with the optional electromagnetic interference gasket mounted on the nose thereof.

### DETAILED DESCRIPTION OF THE INVENTION

The invention is herein described in connection with an SC, single mode, 9-pin, transceiver module for OC3, OC12 and gigabit applications. SC specifies the connector form factor. Single mode specifies that the fibers carry a single ray or mode of light as a carrier. OC3, OC12 and gigabit specify particular wavelength bands for the carrier channel. Finally, 9-pin specifies a particular electrical signal interface that includes 9 interface signal lines. However, it should be understood that this embodiment is exemplary and that the invention can be applied to receivers and transmitters. Further, the invention is not limited to the particular form factor, wavelength or mode type of the exemplary embodiment.

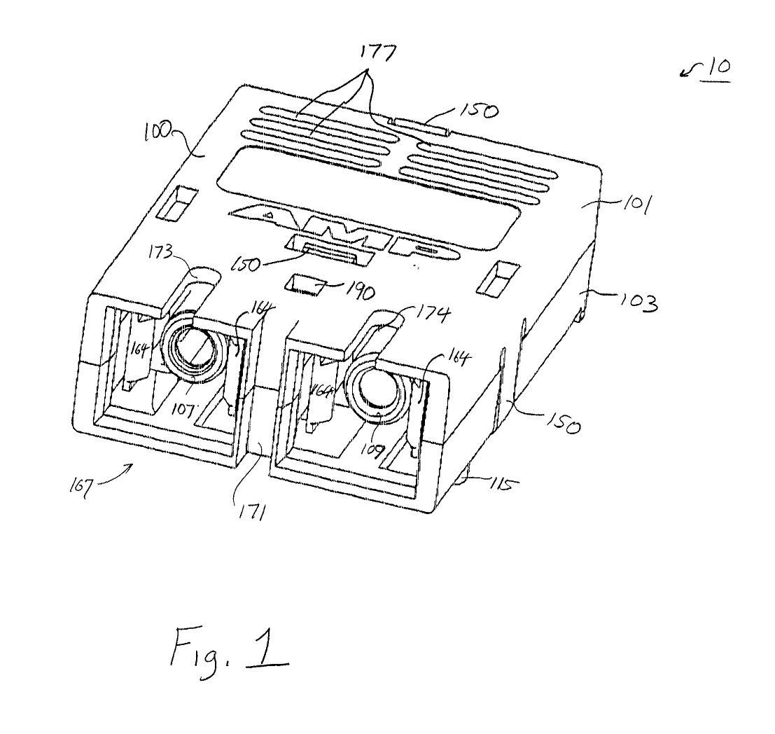

Referring now to the drawings and particularly FIG. 1, which is a perspective view of an optoelectronic SC transceiver in accordance with one preferred embodiment of the present invention, the transceiver 10 comprises a housing 100 formed from two mating portions 101 and 103. The housing portions preferably are non-conductive and may be fabricated from any of the polymers that are commonly used for optoelectronic module housings.

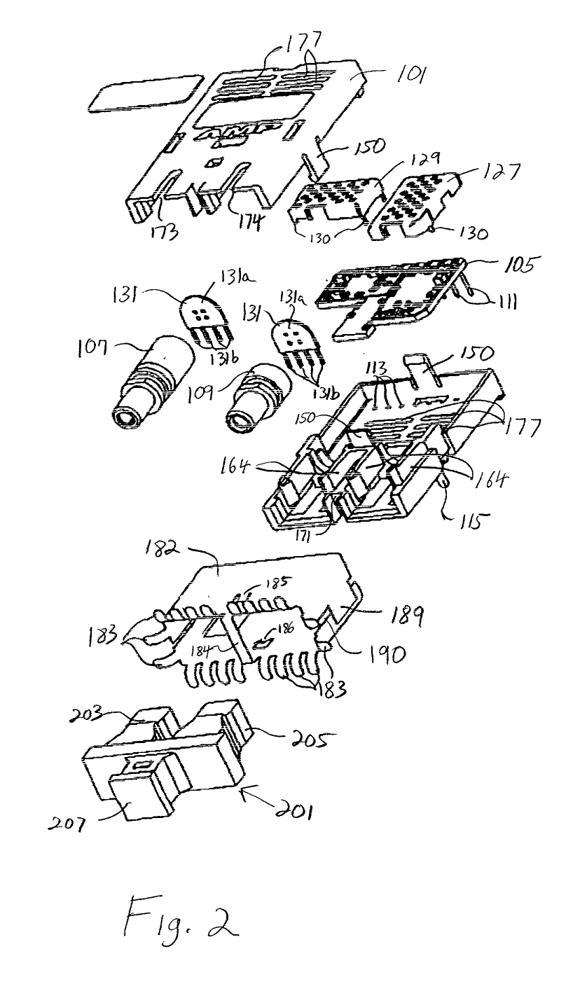

Referring now to FIG. 2, which is an exploded perspective view of the transceiver 10, enclosed within the housing are a printed circuit board 105, a transmit optical subassembly 107, and a receive optical subassembly 109. The printed circuit board 105 is populated with electronic circuitry that conditions the electrical signals as necessary. Such circuitry likely includes at least an amplifier, filters, and a digital potentiometer for adjusting the gain of the amplifier.

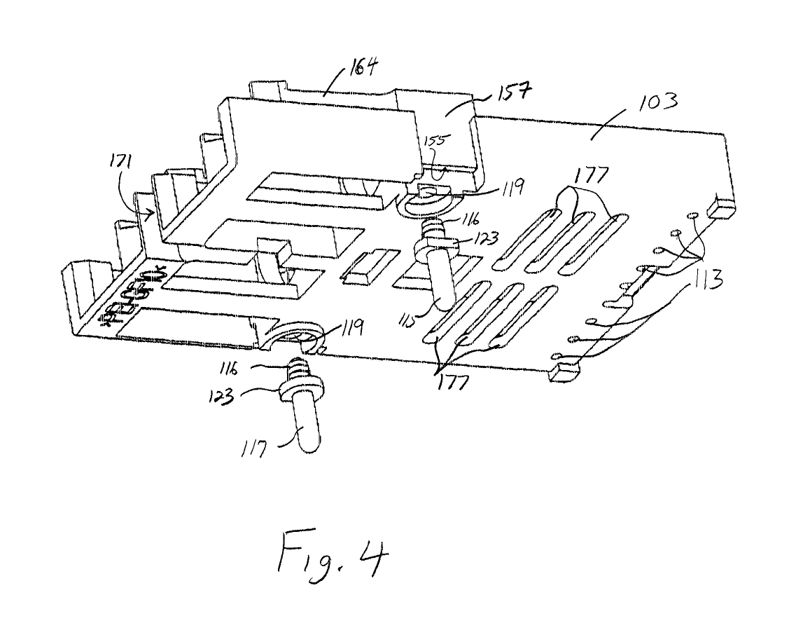

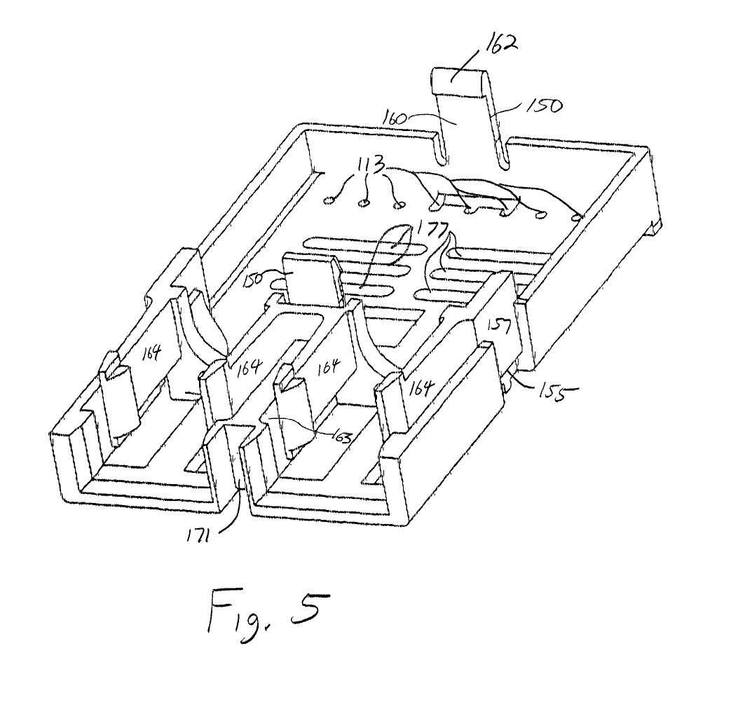

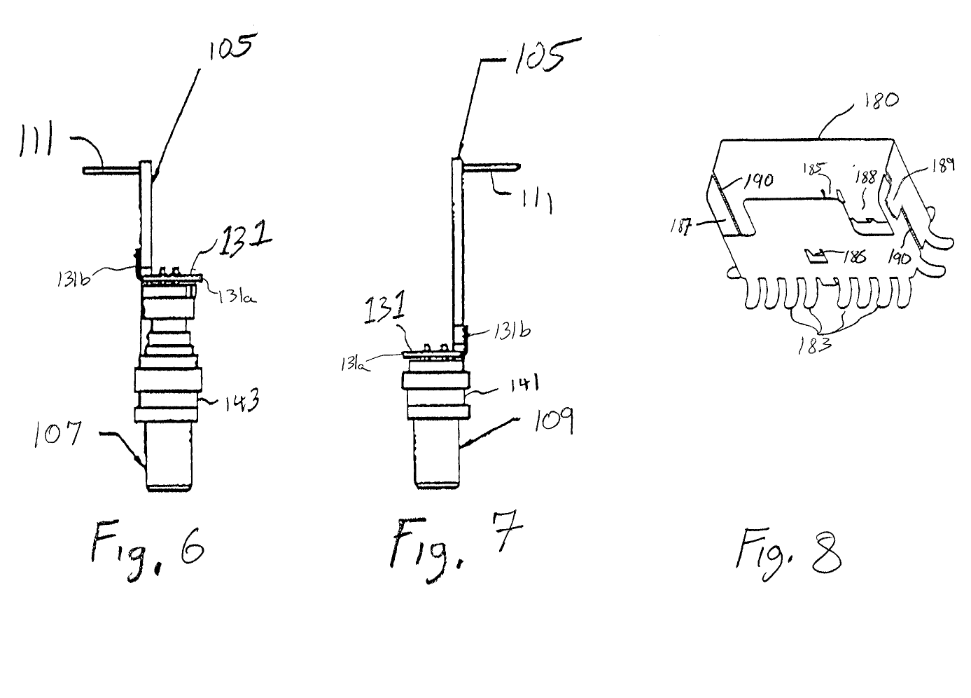

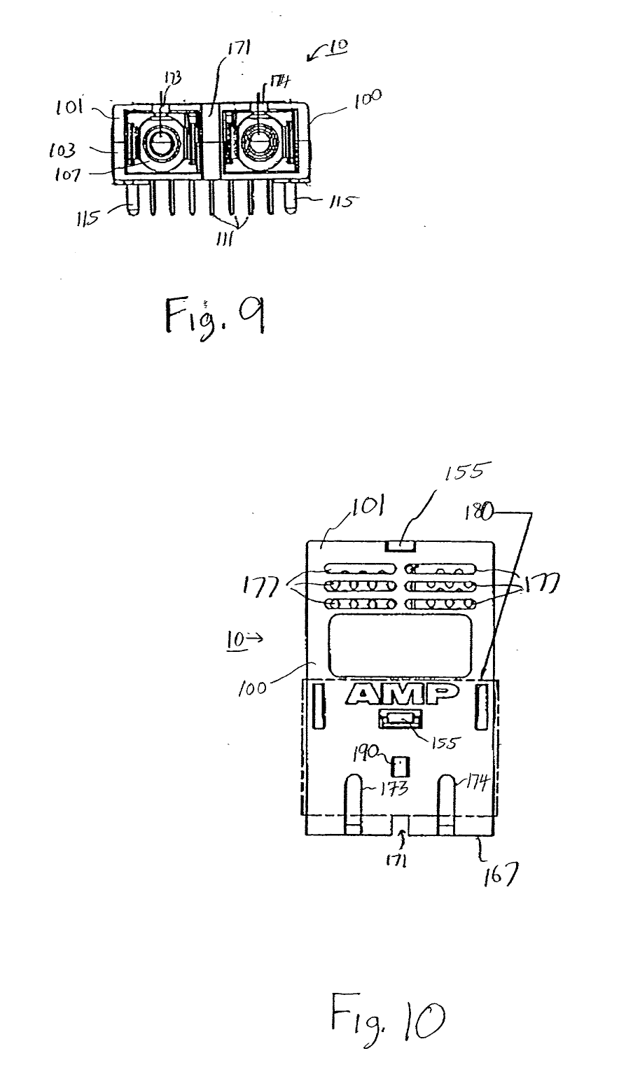

Nine pins 111 protrude from the bottom of the printed circuit board 105 and couple electrical signals between the printed circuit board 105 and external circuitry, such as a host circuit card. Particularly, the printed circuit board 105 is sized and shaped to rest flat in the back portion of the bottom half 103 of the housing with the pins 111 protruding through the holes 113 in the bottom housing half 103. See also FIG. 4, which is a perspective view of the bottom of bottom housing half 103 better showing holes 113 and FIG. 9, which is a front plan view of the assembled module showing pins 111 protruding from the bottom of the module 10. As best shown in FIG. 4, the module further includes two mounting pins 115, which are electrically isolated from the optoelectronic circuitry in the transceiver module 10. Mounting pins 115 may be formed of stainless steel. The proximal end of pins 115 press fit within holes 119 in the bottom surface of the bottom housing half 103. The proximal ends of the pins 115 may include downwardly-angled, circumferential ridges 116 that allow the pins to be inserted upwardly into the holes 119 with the circumferential ridges 116 pressing against the walls of the holes 119, 121 to form a pressure fit within the holes. However, the pins cannot be easily removed because the downwardly directed circumferential ridges 116 bite into the inner walls of the holes 119 when the pins are forced downwardly and prevent downward motion of the pin relative to the hole. Flanges 123 are integrally formed on the pins 115 near the proximal ends of the pins and have a circumference larger than the circumference of the hole and thus limit the extent to which the pins 115 can be inserted into the holes 119 on the bottom of the housing half 103.

The distal ends of the mounting pins 115 will be inserted into mating holes in the host circuit card to physically mount the module on the card. The distal ends of the mounting pins 115 may be soldered or adhered within the holes.

As is well known in the art, electromagnetic interference (EMI) is a particular problem for optoelectronic modules. Accordingly, referring again to FIG. 2, perforated metal EMI shields 127, 129 can be optionally mounted to the top surface of the printed circuit board 105 to cover the electronic circuitry on the printed circuit board and the back ends of the OSAs. Particularly, shields 127 and 129 generally take the form of five sided rectangular boxes with the bottom side open. The side walls include pins 130 that protrude downwardly and engage with mating holes on the printed circuit board 105. The pins 130 may be soldered or adhered within the holes The top surfaces 127a and 129a are perforated. In addition, there may be one or more openings 128 in the side walls to accommodate circuitry populating the PCB 105 and/or the rear portions of the optical subassemblies 107, 109.

With reference to FIGS. 2, 6 and 7, optical subassemblies 107 and 109 are mounted to the printed circuit board by flex circuits 131. Particularly, a flex circuit comprises a flexible circuit board 131a and flexible wires 131b extending therefrom. The flex circuit boards 131a are epoxied to the backs of the optical subassemblies 107, 109. The flexible wires 131b extend therefrom and curl around the edge of the PCB 105 and are soldered to the bottom side of the PCB 105.

Referring now to FIG. 5, which shows the inside of the bottom housing half 103, the bottom half 103 of the housing preferably, includes formations that engage the optical subassemblies 107, 109 when the printed circuit board 105 and optical subassemblies, 107, 109 are inserted into the bottom half of the housing. For instance, extending upwardly from the inner bottom surface of bottom half 103 are two semicircular cutouts 132, 134 that engage circumferential slots 141, 143 in the optical subassemblies 107, 109 (see FIGS. 6 and 7) and generally define the position and orientation of the optical subassemblies.

As best seen in FIGS. 1, 2, 3 and 4, transverse flow-through slots 177 are formed in the rear portions of both halves 101, 103 of the housing 100. As is well known in the art, it is common to immerse an optoelectronic module in an aqueous liquid bath during or at the end of fabrication in order to clean the module. The flow-through slots 177 allow better infiltration of the aqueous solution into the housing and thus allow better cleansing of the OSAs and PCB.

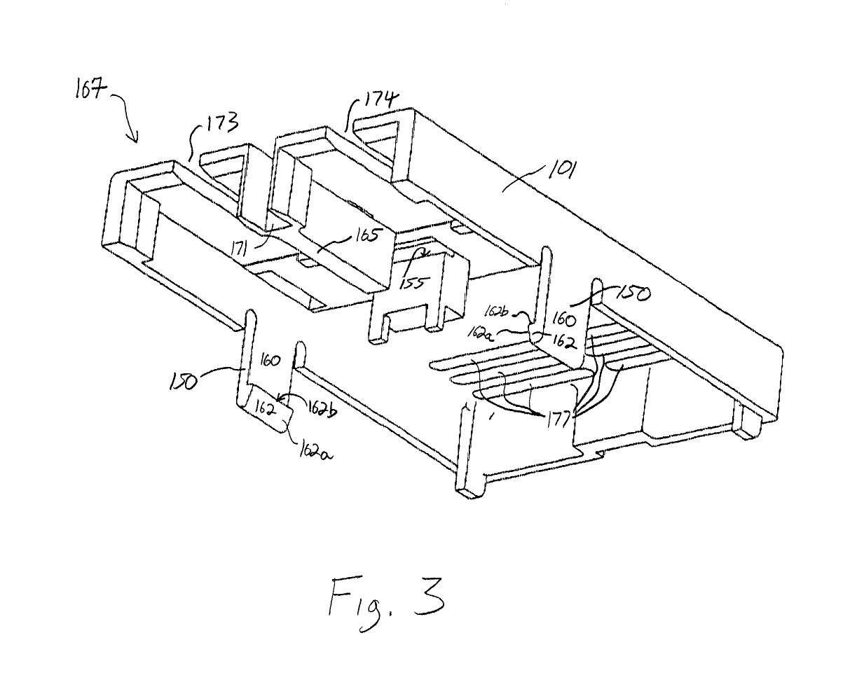

With reference to FIGS. 3 and 5, the top and bottom halves 101, 103 are shaped to mate with each other and enclose the internal components. They couple to each other via latches 150 on one half and mating shoulders 155 on the other half. Preferably, housing halves 101, 103 each include two latches and two shoulders. Each latch 150 comprises a resilient bar 160 that is attached to or integral with the corresponding housing half at its proximal end and includes a dog 162 at its distal end. The dogs 162 comprise an angled outer surface 162a and an inner surface 162b that is normal to the length of the bar portion 160. When the two halves 101, 103 are pushed together, the angled outer surfaces 162a of the dogs 162 engage vertical surfaces 156 adjacent the corresponding shoulders 155 on the other housing half. Because the outer surface 162a of dogs 162 are angled as shown, when the outer surface 162a of the dog 162 encounters the surface 156 adjacent the corresponding shoulder 155 of the other half, it forces the resilient bar 160 to bend outwardly. When the two halves 101, 103 reach the final mating position, the dogs 162 clear the shoulders 155, thus allowing the resilient bars 160 to snap back to their neutral position, thus engaging the inner surface 162b of the dog against the mating shoulder 155 on the other half. The two halves 101, 103 are thus locked together by the latches 150 and shoulders 155.

Because the inner surface 162b of the dogs 162 are parallel to the shoulder, the two halves 101, 103 cannot be separated from each other. However, by simultaneously biasing the bars 160 of all four latches 150 outwardly, the dogs 162 can be disengaged from the corresponding shoulders 155 and the two halves separated. Accordingly, the two halves 101, 103 provide a secure housing that encloses and protects the electronic and optical components of the module, yet the housing can be opened at any stage during manufacturing or afterwards to allow access to the internal components.

This is a substantial advantage over prior art housings in which the optical and electronic circuitry were permanently encapsulated such that access could not be obtained to the optical and electronic circuitry without destruction of the module and/or circuitry itself.

With reference to FIG. 5, in the front end or nose of the bottom half 103 of the housing, four more latches 164 are designed to engage mating shoulders of an SC duplex plug (not shown), as is well known in the art. Integral with the bottom housing half 103 is a wall 163 between the two optical subassemblies 107, 109. Referring to FIG. 3, a mating wall 165 is found in the top housing half 101. When the two halves 101, 103 are brought together, walls 163 and 165 meet and form a full height internal wall that separates the front ends of the optical subassemblies 107 and 109 from each other. The top and bottom housing halves 101, 103 meet to form a front opening 167 of the module (see FIG. 1, for instance). The front of the housing has a recessed wall 171 between the two optical subassemblies. Otherwise the front of the module is open. As best shown in FIGS. 1, 2 and 3, the top half 101 includes two slots 173 and 174 that are open to the front end 167 of the housing. These slots 173 and 174 are generally aligned with the OSAs in the plan views of FIGS. 2 and 3. Slots 173 and 174 accept the key or polarizing member that is found on one side surface of a SC plug. The key on an SC plug and the mating channel or slot on an SC connector is included as part of the SC standard in order to assure that an SC plug can be inserted into an SC connector in only one orientation. The key provides an asymmetric feature in the otherwise symmetric SC form factor.

An external EMI gasket 180 can be mounted on the front end or nose piece of the housing to provide enhanced EMI shielding. With reference to FIG. 8, the gasket 180 includes a main body portion 182 sized and shaped to circumscribe the front end of the housing. The gasket 180 is conductive and is preferably formed of a thin, flexible sheet metal. The bottom surface of the gasket has its rear corners cut out to accommodate the mounting pins 115 and 117. The front end of the gasket includes a plurality of flexible fingers 183 extending generally radially outwardly from the gasket. The front end also includes a support member 184 running vertically down the center of the front of the gasket (see FIG. 2), but is otherwise open at the front and back. The gasket 180 slides onto the front end of the housing until support member 184 meets wall 171 of the housing (best shown in FIGS. 3, 4, and 5), thus defining the proper position of the gasket. FIG. 10 shows the position of the gasket 180 in outline form when mounted on the front end of the module 100.

The gasket further includes two cutout tabs 187 and 188 in the top and bottom sides, respectively. The tabs are resilient and extend from the body of the gasket toward the front opening of the gasket 180 and slightly inwardly. The tabs, preferably, are formed integrally with the gasket by cutting out the surrounding metal. Accordingly, when the gasket is slid onto the nose piece of the module, the tabs 185 and 186 bend outwardly as they contact the top and bottom surfaces of the housing until the gasket is fully inserted, at which point tabs 185 and 186 meet apertures 190, 191 on the top and bottom surfaces, respectively, of the housing (see FIGS. 1 and 4). At that point, they resiliently snap into the apertures and thus prevent the gasket from being slid forward off of the housing. However, if necessary, the gasket can be removed, by bending both tabs 185 and 186 outwardly. This may be accomplished by slipping thin sheets between the gasket 180 and the housing from the rear of the housing so as to bend the tabs outwardly and release them from engagement with the edges of the apertures 190, 191.

In one preferred embodiment of the invention, the gasket is stamped from a single sheet. The sheet is then folded into the shape of the gasket. Plates 189 are then spot welded to the two side surfaces of the gasket. A gap 190 may remain at the sides. Finally, the fingers 183 are bent outwardly.

The fingers 183 of the gasket, are designed to contact the front surface of the face plate or bulk head when the module 100 is mounted in a host device in which the nose extends through a face plate or bulk head. Accordingly, the conductive gasket surrounding the nose piece makes electrical and physical contact with the face plate of the chassis or host device, which, presumably is electrically coupled to chassis ground and thus helps enhance EMI shielding of the module. Since the fingers are resilient, they provide some leeway in the positioning of the module relative to the face plate in the direction of the optical axis of the module. The fingers can flex to accommodate slightly different depths of the module behind the faceplate with the fingers still contacting the front of the faceplate.

Referring again to FIG. 1, a rubber boot 201 may be provided with the module. The boot 201 has a handle 207 and is designed to be inserted into the front end 167 of the module so that the two plugs 203, 205 surround the optical subassemblies 107, 109, respectively. The plugs 203, 205 define cylindrical openings (not seen in the Figures) that slip over and surround the OSAs to protect them prior to deployment of the module. The plugs protect the OSAs in two respects. First, they assist in holding the OSAs steady prior to being coupled to an optical fiber. Recall that the OSAs are coupled to the PCB by flex circuit and thus can move about within the module and possibly damage the wire connectors of the flex circuit. Secondly, the plugs cover the front openings of the OSAs during the aqueous bath stage of fabrication and thus help prevent liquid from entering internally to the OSAs. The boot 201, of course, is removed prior to deployment of the module so that optical fibers can be coupled to the OSAs.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

We claim:

1. An optoelectronic module comprising:
electronic circuitry;
an optical sub-assembly coupled to said electronic circuitry; and
a housing enclosing said electronic circuitry and said optical sub-assembly, said housing comprising first and second mating parts, at least one of said first and second parts comprising a latch and the other of said first and second parts comprising a shoulder positioned to engage said latch when said first and second parts are mated to form said housing and hold said first and second parts together.

2. The optoelectronic module of claim 1 wherein said latch and said shoulder can be disengaged from each other after said first and second parts of said housing are mated.

3. The optoelectronic module of claim 1 wherein said latch comprises a resilient bar having first and second ends, said bar cantilevered from said one part of said housing at said first end and comprising a dog at said second end adapted to engage said shoulder on said other part of said housing.

4. The optoelectronic module of claim 2 wherein said latch and said shoulder comprise a plurality of mating latches and shoulders, said mating latches and shoulders comprising a first subset for which said latch is on said first part and said mating shoulder is on said second part and a second subset for which said latch is on said second part and said mating shoulder is on said first part.

5. The optoelectronic module of claim 2 wherein said latch is accessible from external of said module so that it can be biased out of engagement with said shoulder without damaging said module.

6. The optoelectronic module of claim 3 wherein said housing comprises an outer surface and said second end of said latch is adjacent said outer surface of said housing when assembled and can be biased out of engagement with said mating shoulder manually.

7. The optoelectronic module of claim 1 wherein said housing further comprises slots through which fluid may enter and exit said module.

8. The optoelectronic module of claim 1 further comprising:
electrical connectors protruding from said module for electrically coupling said electronic circuitry to external circuitry.

9. The optoelectronic module of claim 8 wherein said electronic circuitry comprises a printed circuit board and said electrical connectors comprise pins extending from said printed circuit board.

10. The optoelectronic module of claim 8 further comprising a connector adapted to mate with an optical plug of an optical fiber.

11. The optoelectronic module of claim 10 wherein said connector is integral with said housing.

12. The optoelectronic module of claim 1 wherein said electronic circuitry comprises a printed circuit board and said optical sub-assembly is coupled to said printed circuit board by flex circuit.

13. The optoelectronic module of claim 12 wherein said flex allows said optical subassembly to move relative to said printed circuit board.

14. The optoelectronic module of claim 8 further comprising:
a conductive gasket circumscribing said connector.

15. The optoelectronic module of claim 14 wherein said gasket comprises a shell circumscribing said connector and a plurality of fingers extending radially from said shell.

16. The optoelectronic module of claim 15 wherein said fingers are adapted to contact a faceplate when said module is mounted in a chassis with said connector protruding through said faceplate for providing electromagnetic interference shielding.

17. The optoelectronic module of claim 1 wherein said electronic circuitry comprises a printed circuit board, said module further comprising:
a conductive shield sized, shaped, and positioned within said housing to cover said electronic circuitry on said printed circuit board.

18. The optoelectronic module of claim 17 wherein said shield comprises two shields.

19. The optoelectronic module of claim 8 further comprising mounting pins protruding from said housing for mounting said module to external circuitry.
